(19) United States
(12) Patent Application Publication
(10) Pub. No.: US 2009/0197116 A1
(43) Pub. Date: Aug. 6, 2009

(54) METAL HOUSING

(75) Inventors: CHIEN-CHIH CHENG, Shindian (TW); CHIA-HSING CHANG, Shindian (TW); CHAO-HSUN LIN, Shindian (TW)

Correspondence Address: PCE INDUSTRY, INC.;ATT. Steven Reiss, 458 E. LAMBERT ROAD, FULLERTON, CA, 92835, US

(73) Assignee: FIH (HONG KONG) LIMITED, Kowloon (HK)

(21) Appl. No.: 12/141,227

(22) Filed: Jun. 18, 2008

(30) Foreign Application Priority Data
Feb. 1, 2008 (CN) 200810300298.2

(51) Int. Cl. B32B 15/01

(52) U.S. Cl. 428/651; 428/660

(57) ABSTRACT

A metal housing (10) includes a first metal layer (11) and a second metal layer (12). The material of the first metal layer is selected from the group consisting of stainless steel, titanium and titanium alloy. The material of the second metal layer is selected from the group consisting of aluminum, aluminum alloy and magnesium alloy. The second metal layer is integrally formed with the first metal layer.

### BACKGROUND

1. Field of the Invention

The present invention relates to metal housings, particularly, to a metal housing made of at least two metal materials.

2. Description of Related Art

Portable electronic devices, such as mobile telephones, personal digital assistants, and MP3 players, enable consumers to enjoy the convenience of high technology services, almost anytime and at virtually anywhere. These mobile devices often employ any of a variety of decorative housings to attract consumers. The housings may be formed of a plastic or other polymeric material, of a metal such as stainless steel, aluminum, aluminum alloy, magnesium alloy and titanium alloy. Plastic or other polymeric materials are light and inexpensive. However, these materials are not very strong and cannot shield against electromagnetic interference. Metal materials can shield against electro-magnetic interference. However, metal materials also have shortcomings, e.g., aluminum, aluminum alloy or magnesium alloy are inexpensive but have poor rigidity; stainless steel and titanium alloy have good rigidity but are expensive.

Therefore, a new metal housing for portable electronic device is desired in order to overcome the above-described problems.

### BRIEF DESCRIPTION OF THE DRAWINGS

Many aspects of metal housing can be better understood with reference to the following drawings. The components in the drawings are not necessarily drawn to scale, the emphasis instead being placed upon clearly illustrating the principles of the present portable electronic device, in which:

FIG. 1 is an isometric view of a metal housing, in accordance with an exemplary embodiment of the present invention;

FIG. 2 is a cross sectional view of the metal housing along line II-II shown in FIG. 1; and

FIG. 3 illustrates a different embodiment of a metal housing.

### DETAILED DESCRIPTION OF THE EMBODIMENTS

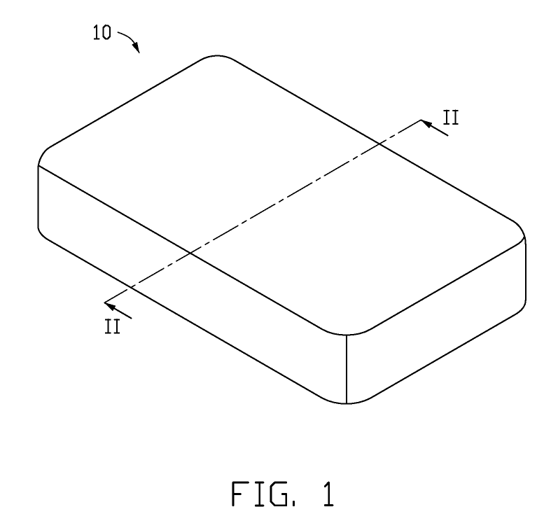

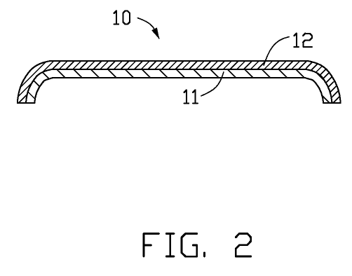

Referring to FIGS. 1-2, a metal housing 10 which is suitable for use with an exemplary portable electronic device, such as a mobile phone, an MP4 player, a PDA (personal digital assistant) or the like, includes a first metal layer and a second metal layer, in accordance with an exemplary embodiment of the present invention. The material for the first metal layer 11 is selected from the group consisting of stainless steel, titanium and titanium alloy. Thus the first metal layer 11 provides good mechanical strength to the metal housing 10. The material of the second metal layer 12 is selected from the group consisting of aluminum, aluminum alloy and magnesium alloy. The material for the second metal layer 12 is inexpensive, thus reducing the cost of producing the electronic device using the metal housing 10.

The thickness of the metal housing 10 is about 0.3˜1 mm. The proportion of the thickness of the first metal layer 11 to that of the second metal layer 12 varies according to the material of the first metal layer 11. E.g., if the first metal layer 11 is made of titanium or titanium alloy which has good ductility, the proportion of the thickness of the first metal layer 11 to that of the second metal layer 12 may be approximately 1:4; if the first metal layer 11 is made of stainless steel, the ductility of which is poorer than titanium or titanium alloy, the proportion of the thickness of the first metal layer 11 to the second metal layer 12 may be approximately 2:3.

The metal housing 10 has an inner surface and an outer surface. The inner surface can be formed by one of the first metal layer 11 and the second metal layer 12, while the outer surface is formed by the other of the first metal layer 11 and the second metal layer 12.

FIG. 2 shows that in this embodiment the inner surface of the metal housing 10 is formed by the first metal layer 11 and the outer surface of the metal housing 10 is formed by the second metal layer 12. The outer surface formed by the second metal layer 12 can have surface treatments applied thereon. The surface treatments applied on the outer surface formed by the second metal layer 12 may include electrochemical treatments, chemical treatments and coatings. Thus the metal housing 10 can be made to have any of various beautiful appearances.

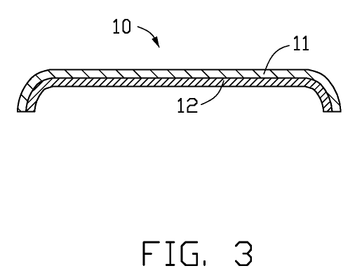

FIG. 3 shows another embodiment. The outer surface of the metal housing 10 is formed by the first metal layer 11 and the inner surface of the metal housing 10 is formed by the second metal layer 12. The outer surface formed by the second metal layer 12 can give a strong metalic appearance to the metal housing 10. However, despite any shading symbology used in the drawings, the housing 10 can be made from a variety of different materials to have any of various beautiful appearances.

In a method of manufacturing the metal housing 10, a first metal plate and a second metal plate are provided. The material of the first metal plate is selected from the group consisting of stainless steel, titanium and titanium alloy. The material of second metal plate is selected from the group consisting of aluminum, aluminum alloy and magnesium alloy. The first metal plate and the second metal plate are bonded together by pressing means such as rolling and exploding. The bonded plates are then formed to be the metal housing 10 by means of punching.

It should be understood that the metal housing 10 is manufactured with the first metal layer 11 and the second metal layer 12. The first metal layer 11 has good mechanical strength and the second metal layer 12 is inexpensive. Thus, the metal housing 10 is both strong and cost effective.

It is to be further understood that the metal housing also can be used as a shell for other devices such as a host computer or as a container of some kind, such as a eyeglass case, writing utensil case, cup and so on.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A metal housing comprising:
a first metal layer selected from the group consisting of stainless steel, titanium and titanium alloy; and
a second metal layer selected from the group consisting of aluminum, aluminum alloy and magnesium alloy, the second metal layer integrally formed with the first metal layer.

2. The metal housing as claimed in claim 1, wherein the first metal layer and the second metal layer are bonded together by pressing.

3. The metal housing as claimed in claim 1, wherein first metal layer and the second metal layer are bonded together by rolling.

4. The metal housing as claimed in claim 1, wherein the metal housing comprises an inner surface and an outer surface, the inner surface being formed by the first metal layer, and the outer surface being formed by the second metal layer.

5. The metal housing as claimed in claim 4, wherein the outer surface of the metal housing has surface treatment applied thereon.

6. The metal housing as claimed in claim 5, wherein the surface treatment is selected from the group consisting of electrochemical treatments, chemical treatments and coatings.

7. The metal housing as claimed in claim 1, wherein the metal housing comprises an inner surface and an outer surface, the outer surface being formed by the first metal layer, and the inner surface being formed by the second metal layer.

8. The metal housing as claimed in claim 1, wherein the thickness of the metal housing is 0.3˜1 mm.

9. The metal housing as claimed in claim 1, wherein the metal housing is formed by means of punching a bonded plate made up of the first metal layer and the second metal layer.

10. The metal housing as claimed in claim 1, wherein the first metal layer is made of titanium or titanium alloy, and the proportion of the thickness of the first metal layer to that of the second metal layer is 1:4.

11. The metal housing as claimed in claim 1, wherein the first metal layer is made of stainless steel, and the proportion of the thickness of the first metal layer to that of the second metal layer is 2:3.
